(19) United States
(12) Patent Application Publication
(10) Pub. No.: US 2015/0097074 A1
(43) Pub. Date: Apr. 9, 2015

(54) DUAL-FREQUENCY ACTIVE VIBRATION CONTROL

(71) Applicant: Sikorsky Aircraft Corporation, Stratford, CT (US)

(72) Inventors: Joseph John Andrews, Hamden, CT (US); Thomas A. Millott, Milford, CT (US)

(73) Assignee: Sikorsky Aircraft Corporation, Stratford, CT (US)

(21) Appl. No.: 14/045,140

(22) Filed: Oct. 3, 2013

(51) Int. Cl. B64C 27/00

(52) U.S. Cl. CPC B64C 27/001; B64C 2027/004
USPC 244/17.13

(57) ABSTRACT

A system for active vibration control includes an actuator configured to reduce the impact of a vibratory load imposed on an airframe of a rotorcraft to an amount that is less than a threshold; and a controller configured to determine the vibratory load based on the data, and set an eccentric rotational speed of an actuator at a first frequency and modulate the eccentric rotational speed by a second frequency based on the vibratory load. Also a method includes obtaining, by the controller, data; determining, by the controller, a vibratory load based on the data; and setting, by the controller, an eccentric rotational speed of an actuator at a first frequency and modulating the eccentric rotational speed by a second frequency based on the vibratory load.

### BACKGROUND

Environmental conditions associated with the operation of an aircraft may impose stress or strain on the aircraft. For example, a rotor hub associated with a rotorcraft may experience vibratory loads caused by aerodynamic forces on the blades. The blade loads may be summed at the hub and, if not attenuated, may be propagated through the rotor shaft and main transmission into the airframe.

An approach to controlling fuselage vibration has involved the use of hub-mounted passive absorbers tuned to attenuate the dominant rotating system vibration frequency (e.g., 3/rev for a four-bladed rotor) as well as 4/rev active vibration control (AVC) fixed system actuators throughout the fuselage. Many aircraft are equipped with a 3/rev bifilar to suppress some of the in-plane loads as well as fixed system AVC. These configurations only suppress 4/rev vibration and leave other frequencies, such as 2/rev or 8/rev un-attenuated. Some aircraft use two complete AVC systems to be able to attenuate both 2/rev and 4/rev, resulting in added aircraft weight.

### BRIEF SUMMARY

An embodiment is directed to a method that includes obtaining, by a controller comprising a processor, data; determining, by the controller, a vibratory load based on the data; and setting, by the controller, an eccentric rotational speed of an actuator at a first frequency and modulating the eccentric rotational speed by a second frequency based on the vibratory load.

Another embodiment is directed to an apparatus having at least one processor; and memory having instructions stored thereon that, when executed by the at least one processor, cause the apparatus to: obtain data, determine a vibratory load based on the data, and set an eccentric rotational speed of an actuator at a first frequency and modulate the eccentric rotational speed by a second frequency based on the vibratory load.

Another embodiment is directed to a system having an actuator configured to reduce the impact of a vibratory load imposed on an airframe of a rotorcraft to an amount that is less than a threshold; and a controller configured to: obtain data, determine the vibratory load based on the data, and set an eccentric rotational speed of an actuator at a first frequency and modulate the eccentric rotational speed by a second frequency based on the vibratory load.

Another embodiment is directed to a system having a motor configured to spin an eccentric mass to provide a force output characterized by a plurality of frequencies associated with an operation of a rotor; and an electronics unit coupled to the motor and configured to determine a desirable position of the mass to obtain the force output.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system according to an embodiment of the invention;

FIG. 2A illustrates a system for providing active vibration control (AVC) on a rotorcraft according to an embodiment of the invention;

FIG. 2B illustrates a block diagram of a system for providing AVC according to an embodiment of the invention;

FIG. 3 is a flow chart of an exemplary method according to an embodiment of the invention;

FIG. 4A-4H is a schematic representation of an actuator for use in an active vibration control system according to an embodiment of the invention;

FIG. 5A depicts simulation data for the induced rotational speed of eccentric masses according to an embodiment of the invention;

FIG. 5B depicts simulation data for the induced inertial torque of the eccentric masses according to an embodiment of the invention;

FIG. 5C illustrates simulation data for a time domain response of the induced force in system according to an embodiment of the invention; and

FIG. 5D is simulation data for a FFT spectrum to a disturbance in two eccentric mass according to an embodiment of the invention.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for providing active vibration control (AVC). In some embodiments, the AVC may be used to mitigate the impact of two distinct frequencies. Eccentric rotational speed of an AVC actuator may be modulated, such that the actuator produces a controllable force output at the two distinct frequencies.

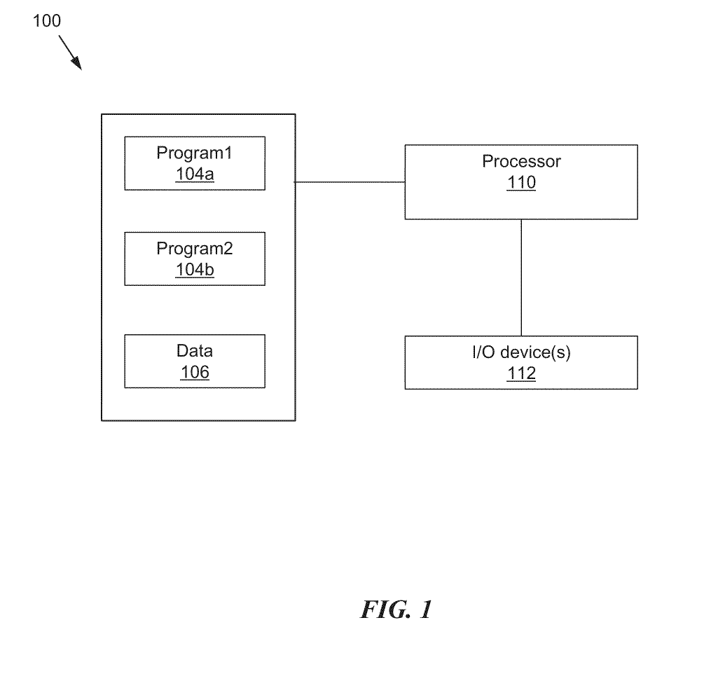

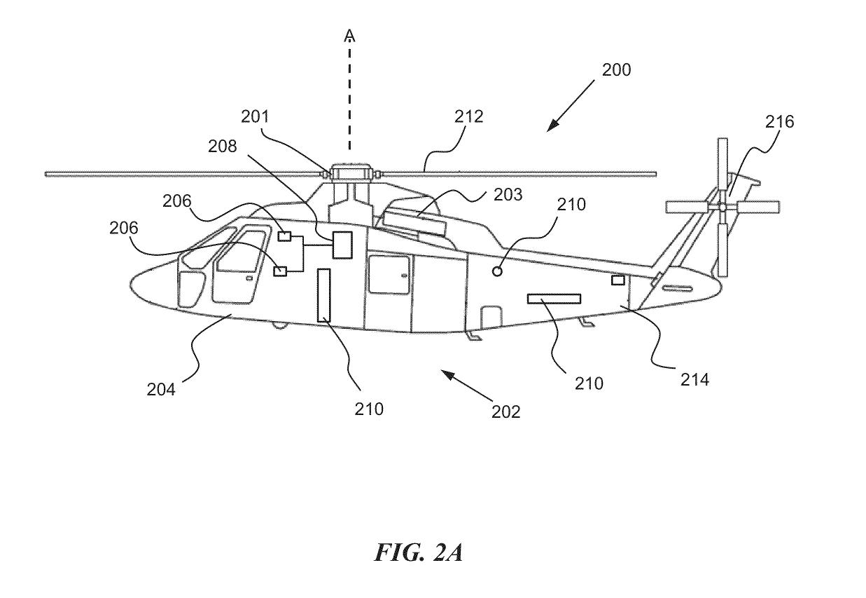

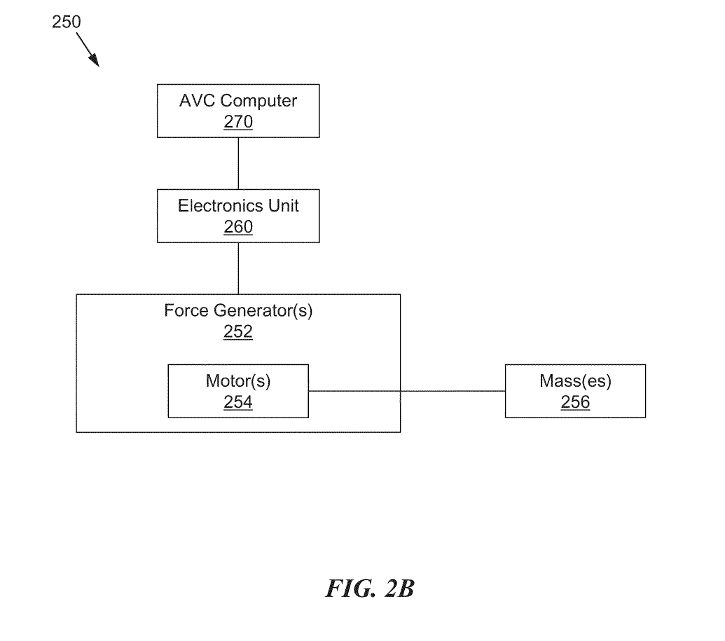

Referring to FIG. 1, an exemplary computing system 100 implemented on rotary wing aircraft 200 (FIG. 2A) is shown. The system 100 is shown as including a memory 102. The memory 102 may store executable instructions. The executable instructions may be stored or organized in any manner and at any level of abstraction, such as in connection with one or more processes, routines, methods, etc. As an example, at least a portion of the instructions are shown in FIG. 1 as being associated with a first program 104a and a second program 104b. The memory 102 may include random access memory (RAM), read only memory (ROM), or other electronic, optical, magnetic, or a combination of RAM, ROM, or other computer readable medium in the same or different locations connected over a network.

The memory 102 may be configured to store data 106. Data 106 may include data originating from one or more sources. The data 106 may pertain to one or more parameters, such as an eccentric rotational speed, force, torque, etc.

The instructions stored in the memory 102 may be executed by one or more processors, such as a processor 110. The processor 110 may be configured to process the data 106. It is to be understood that the data 106 may be stored on separate media from the programs 104a, 104b.

The processor 110 may be coupled to one or more input/output (I/O) devices 112. In some embodiments, the I/O device(s) 112 may include one or more of a keyboard or keypad, a touchscreen or touch panel, a display screen, a microphone, a speaker, a mouse, a button, a remote control, a joystick, a printer, etc. The I/O device(s) 112 may be configured to provide an interface to allow a user or another entity (e.g., another computing entity) to interact with the system 100. The device 112 may also be configured to transmit or receive sensor data and/or commands to the processor 110.

The system 100 is illustrative. In some embodiments, one or more of the entities may be optional. In some embodiments, additional entities not shown may be included. In some embodiments, the entities may be arranged or organized in a manner different from what is shown in FIG. 1. One or more of the entities shown in FIG. 1 may be associated with one or more of the devices or entities described herein.

FIG. 2A illustrates a system 202 for providing an active vibration control (AVC) control system on a rotary wing aircraft (or rotorcraft) 200 according to an embodiment of the invention. The system 202 may be implemented in connection with the system 100 of FIG. 1 on aircraft 200 as illustrated, but the invention is not limited thereto.

As illustrated in FIG. 2A, rotorcraft 200 includes an airframe 204 with an extending tail 214 and a tail rotor 216 located thereon. While the embodiment of a rotorcraft 200 described herein includes an extending tail 214 and tail rotor 216, it is to be appreciated that the disclosure herein may be applied to other types of helicopters as well as rotorcraft 200 of other configurations. A main rotor assembly 201 is located at the airframe 204 and rotates about a main rotor axis A. The main rotor assembly 201 is driven by one or more internal combustion engines 203 which causes rotation of blades 212 to provide lift and thrust to the airframe 204. The airframe 204 is lifted by the main rotor assembly 201 and houses the sensors 206, actuator 210, and controller 208. Not shown for simplicity are other elements associated with an aircraft, such as an engine transmission system including a gearbox, etc. The rotation of the main rotor assembly 201 and the associated blades 212 may cause vibratory loads to be experienced by the airframe 204. To suppress vibration of the airframe 204 resulting from, for example, rotation of the main rotor assembly 201 about the main rotor axis A, a number of AVC actuators 210 are located in the airframe 204 that may be associated with one or more eccentric masses that are coupled to fuselage 204 in order to produce one or more outputs that may mitigate the impact or effect of the vibration caused by the main rotor assembly 201, as will be described below in FIG. 2B.

The system 202 may include one or more sensors, such as a sensor 206 located on the airframe 204. The sensor 206 may be configured to detect or measure the extent of the vibration caused by the operation and use of the blades 212, potentially as a function of a rotational speed or rotational frequency associated with the main rotor assembly 201. In some embodiments, the sensor 206 may include one or more accelerometers. The sensor 206 may provide data pertaining to the vibration to a controller 208.

The controller 208 may be configured to process the data from the sensor 206. Based on the data processing, the controller 208 may cause one or more commands or directives to be issued to the actuator 210 which acts as an active vibration controller to offset or cancel vibratory loads on the airframe 204. In some embodiments, the commands or directives may serve to modulate an eccentric rotational speed associated with the actuator 210. In exemplary embodiments, the eccentric rotational speed is set at a first frequency. The eccentric rotational speed is modulated by a second frequency to provide a force output at two distinct frequencies.

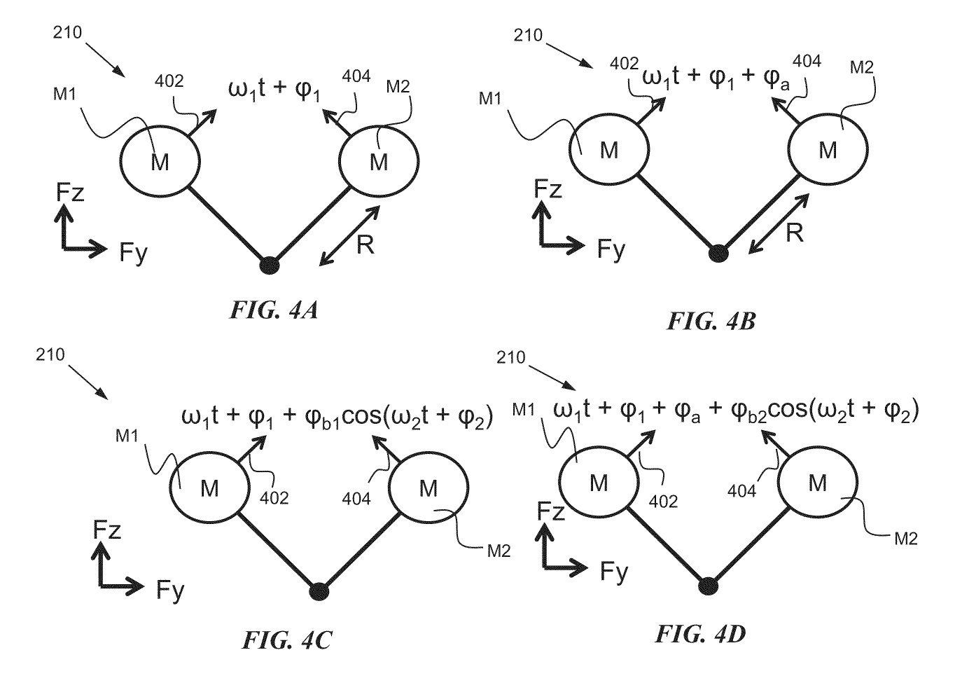

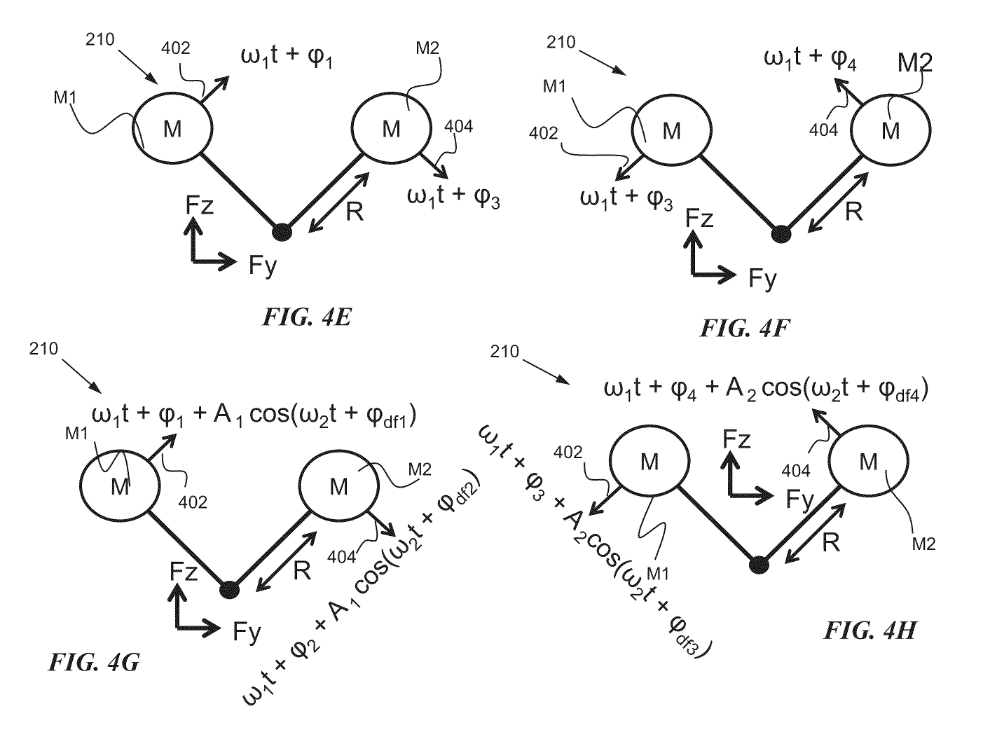

The actuator 210 may be associated with one or more eccentric masses (not shown). The actuator 210 may be configured to produce one or more outputs that may mitigate (e.g., cancel) the impact or effect of the vibration caused by the main rotor assembly 201 on the airframe 204. For example, the actuator 210 may be configured to control the mass(es) to produce a force that is approximately equal to (e.g., within a threshold of the magnitude of), but opposite in sign from, the forces generated as a result of the operation/vibration associated with the main rotor assembly 201. In some embodiments, the force produced or caused by the actuator 210 may be characterized by two (or more) distinct frequencies, as will be described below in FIGS. 4A-4H. In this manner, the system 202 may be used to control or mitigate a plurality of frequencies associated with the vibration caused by operating the main rotor assembly 201.

Referring now to FIG. 2B, a system 250 for providing active vibration control (AVC) is illustrated. The system 250 includes a number of entities as described further below. The entities may be associated with, or include, one or more components or devices, such as those described herein. For example, the system 250 may include one or more of the components and devices described above with respect to the systems 100 and 200 such as, for example, the actuators 210 and the controller 208.

As shown in FIG. 2B, the system 250 may include one or more mechanical units or force generators 252. The force generator 252 may include one or more motors 254. The force generator 252 or motor 254 may cause one or more eccentric masses 256 to spin to provide a force output that may serve to mitigate or counteract the impact of two or more vibration frequencies (e.g., 4/rev and 8/rev on an aircraft with four blades).

The force generator 252 may be coupled to an electronics unit 260. The electronics unit 260 may provide power to the force generator 252 to control the motor 254. The force generator 252 may provide feedback to the electronics unit 260 regarding the position or location of the eccentric masses 256. The electronics unit 260 may provide directives or commands to the force generator 252 regarding a desired position for the mass 256 in order to realize a damping effect at two or more of the vibration frequencies.

The electronics unit 260 may be coupled to an AVC computer 270. The electronics unit 260 may provide power to the AVC computer 270. The AVC computer 270 may be configured to receive data, such as data pertaining to accelerometer readings or measurements. Based on a processing of the data, the AVC computer 270 may calculate one or more parameters, such as an amplitude, phase, force, or frequency that should be realized by the force generators 252. The AVC computer 270 may provide such parameters to the electronics unit 260, and the electronics unit 260 may process the parameters to determine the desired position for the mass 256 as described above.

The systems 200 and 250 are illustrative. In some embodiments, one or more of the entities may be optional. In some embodiments, additional entities not shown may be included. In some embodiments, the entities may be arranged or organized in a manner different from what is shown in FIGS. 2A-2B. In some embodiments, the entities may be at least partially combined.

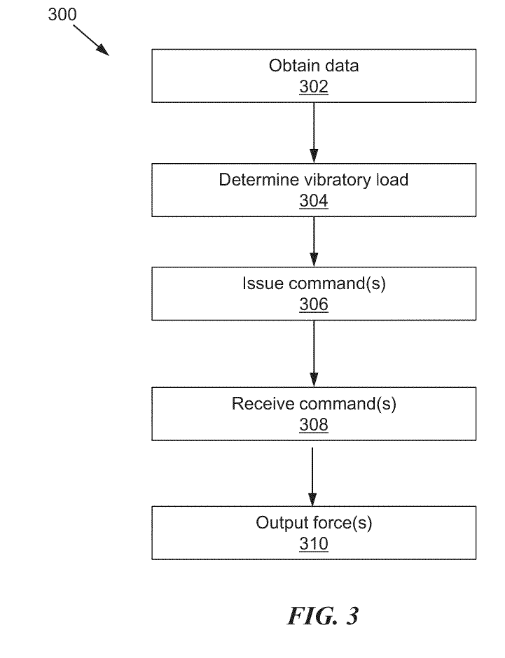

Turning to FIG. 3 with continued reference to FIG. 2A, a flow chart of an exemplary method 300 is shown. The method 300 may be executed in connection with one or more entities, components, devices, or systems, such as those described herein. The method 300 may be used to modulate an actuator eccentric rotational speed.

In block 302, data may be obtained from one or more sources. For example, in connection with FIG. 2A, data may be obtained from the sensor(s) 206 as one or more signals. The obtained sensor data may be indicative of a vibratory load imposed on the airframe 204 of the rotorcraft 200 by the operation of an engine 203 or main rotor assembly 201.

In block 304, a determination or calculation may be made regarding the vibratory load imposed on the airframe 204 based on the received sensor data obtained in block 302. The determination/calculation may be made by, e.g., a controller 208.

In block 306, one or more signals representative of commands or directives may be issued by, e.g., a controller 208. The commands/directives may serve to modulate an eccentric rotational speed associated with an actuator 210 at two or more frequencies.

In block 308, the one or more commands of block 306 may be received by, e.g., the actuator 208 as signals.

In block 310, one or more forces may be output by, e.g., the actuator 210. The forces may be based on the received commands of block 308. The forces may be associated with more than one frequency.

The method 300 is illustrative. In some embodiments, one or more of the blocks or operations may be optional. In some embodiments, additional blocks or operations not shown may be included. In some embodiments, the blocks or operations may execute in an order or sequence different from what is shown in FIG. 3.

FIG. 4A-4H schematically represents a conventional rotary actuator 210 (FIG. 2B) with eccentric masses M1, M2 which may be used in the system 250 according to an exemplary embodiment of the invention. As illustrated and with continued reference to FIG. 2B, the actuator 210 includes substantially similar concentric masses Ml, M2 that may be co-rotated in the direction indicated by arrows 402, 404 by modulating the speed of the shaft that is connected to the masses M1, M2. As the rotational frequency of a conventional rotor is generally 4.3 Hz, and with four blades, the blade passage frequency may be characterized as 4P (4 per rev) of 17.2 Hz. As such, the rotational speed (4P) of the mass M1, M2 is generally 17.2 Hertz (cycles per second) or 1032 revolution per minute (rpm). The masses M1, M2 may produce a single or two resonant frequencies in order to dampen 4P and 8P vibrations by the blades 212 (FIG. 2B). An eccentric mass M1, M2 on a shaft generates a centripetal force at the frequency of rotation because the mass is off-center from the shaft. The masses M1, M2 are connected to an airframe 204 (FIG. 2A) at selective modified distance R and are actuated by force generators(s) 252 (FIG. 2B to cause the masses M1, M2 to rotate at one or more angular speeds. The eccentric masses M1, M2 are displaced in parallel planes and may be tuned to produce two different resonant frequencies. The inherent dual resonant frequencies (ω₁t, ω₂t) are 17.2 Hz and 34.4 Hz. In an embodiment, the rotary actuators 210 oppose the propagation of vibration by controlling the angular positions of the masses M1, M2 to produce single or dual frequency linear or biaxial forces to counteract the vibrations in the airframe 204 (FIG. 2A).

In the example illustrated in FIG. 4A-AB, each eccentric mass M1, M2 is illustrated as producing a linear output force component at a single frequency (ω₁t), where:

Fz=4 MRω₁²(1−(|mod(φₐ,+/−π)|/π)) cos(ω₁t+φ₁) (1)

Fy=0 (2)

In the example illustrated in FIG. 4C-4D, each eccentric mass M1, M2 is illustrated as producing a linear output force component at a dual frequency (ω₁t , ω₂t), where:

Fz=4 MRω₁²(1−(|mod(φₐ,+/−π)|π))cos(ω₁t+φ₁)+F₂cos((ω₁+ω₂)t+φ₂) (3)

Fy=0 (4)

F₂=g(φ_{b1}, φ_{b2},M,R) (5)

In the example illustrated in FIG. 4E-4F, each eccentric mass M1, M2 is illustrated as producing a linear biaxial output force component at a single frequency (ω₁t , ω₂t), where:

Fz=4 MRω₁²(1−(|mod(φₐ,+/−π)|/π))cos(ω₁+ω₂)t+φ₂) (6)

Fy=0 (7)

In the example illustrated in FIG. 4E-4F, each eccentric mass M1, M2 is illustrated as producing a linear biaxial output force component at a dual frequency (ω₁t , ω₂t), where:

Fz=4 MRω₁²(1−(|mod(φₐ,+/−π)|/π)cos(ω₁t+φ₁)+F₂cos((ω₁₊ω₂)t+φ₂) (8)

Fy=0 (9)

F₂=g(φ_{b1}, φ_{b2},M,R) (10)

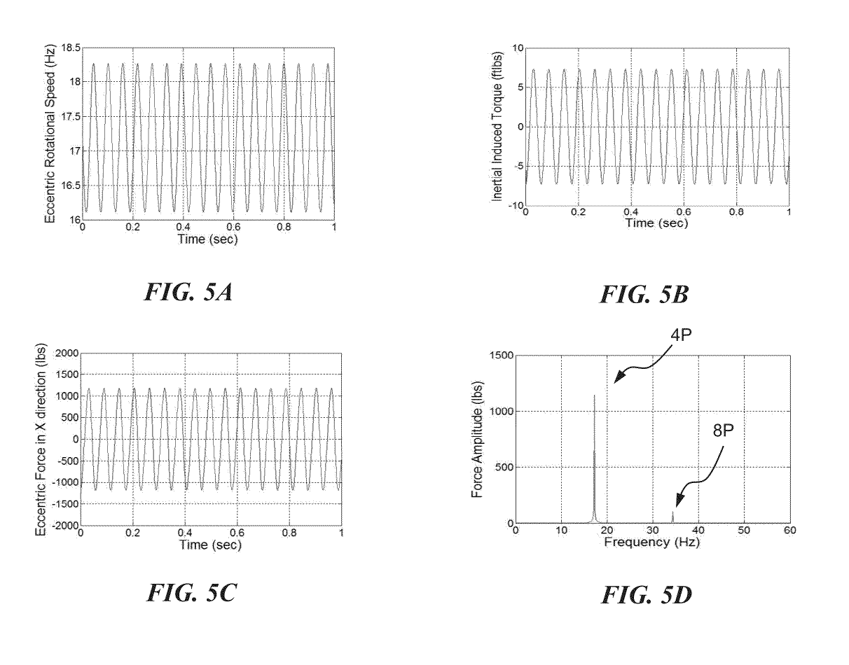

FIG. 5A-5D is a graphical representation of simulation data for modulating an eccentric mass such as, e.g., M1 or M2 of FIG. 4A-4H according to an embodiment of the invention. As illustrated, FIG. 5A depicts simulation data for the induced rotational speed of an eccentric mass M1 associated with a force generator 252. As illustrated in the figure, the resonant frequency that is being induced in the eccentric mass M1 by approximately 17.2 Hz which corresponds to 1032 revolution per minute (rpm) or 4 per rev of the rotors 212. It is to be appreciated that each force generator 252 includes two eccentric masses M1, M2 and an 8P harmonic response may be generated by modulating a rotational speed of a second eccentric mass, e.g., M2 through a first eccentric mass M1. FIG. 5B depicts, simulation data for the inertial torque that is being induced by eccentric mass M1 for a force generator 252. FIG. 5C illustrates simulation data for a time domain response of the induced force in system 250 (FIG. 2B) for eccentric mass M1. FIG. 5D is simulation data for a FFT spectrum relating to a disturbance in two eccentric mass(es) M1, M2 of which the two distinct frequencies at 4P and 8P are exhibited. As illustrated in FIG. 5D, by modulating an eccentric mass M1 at a rotational speed at 4 per rev and modulating a second mass M2 at 4 per rev produces a force component at 4 per rev and a smaller force component at 8 per rev. The modulation of the 4 per rev by changing the rotational speed and phase of, e.g., an eccentric mass M2 causes the second harmonic at 8P or 8 per rev to be generated (i.e., a controllable second induced force component). It is to be appreciated that the 8P harmonic can control the second harmonic by adjusting the phase and amplitude of the modulation. In some embodiments, an actuator eccentric rotational speed may be modulated. If the torque induced by the modulation is within motor limits, no additional weight penalty may be incurred (neglecting any potential housing requirements). Embodiments may be used to attenuate multiple vibratory frequencies associated with the operation of a rotor using a single AVC platform. Accordingly, the weight of an aircraft may be less than if a plurality of AVC platforms were used to attenuate a corresponding plurality of vibratory frequencies.

In some embodiments, energy harvesting may be performed. The energy harvesting may be based on a cyclic nature of a given modulation technique and may mitigate any additional power requirements that may be imposed.

Embodiments may be used to produce or generate a controllable force output at two or more frequencies. For example, in connection with the operation of a rotor with four blades, a force output may be generated at a fundamental frequency, which may be 4/rev in this example. The force output may include frequency components at multiples of the fundamental frequency (e.g., 8/rev, 12/rev, 16/rev, etc., in the case of a rotor with four blades). In some embodiments, the force output may include frequency components that are not multiples of the fundamental frequency. For example, integer variations or increments of the fundamental frequency (e.g., 5/rev, 6/rev, 7/rev, etc., in the case of a rotor with four blades) may be included in the force output.

Embodiments have been described in connection with the operation of aircraft or rotorcraft. Aspects of this disclosure may be applied in other contexts. For example, aspects of this disclosure may be used in any environment where vibratory frequencies need to be controlled, such as in the manufacturing of semiconductors.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
obtaining, by a controller comprising a processor, data;
determining, by the controller, a vibratory load based on the data; and
setting, by the controller, an eccentric rotational speed of an actuator at a first frequency and modulating the eccentric rotational speed by a second frequency based on the vibratory load.

2. The method of claim 1, wherein the vibratory load is based on an operation of a rotor.

3. The method of claim 1, wherein the vibratory load is imposed on an airframe of an aircraft, and wherein the at least one command is configured to cause the actuator to mitigate the impact of the vibratory load on the airframe.

4. The method of claim 1, wherein the at least one command is configured to cause the actuator to produce a force output characterized by at least the first and second frequencies.

5. The method of claim 1, wherein the controller obtains the data from at least one sensor coupled to an airframe of an aircraft.

6. An apparatus comprising:
at least one processor; and
memory having instructions stored thereon that, when executed by the at least one processor, cause the apparatus to:
obtain data,
determine a vibratory load based on the data, and
set an eccentric rotational speed of an actuator at a first frequency and modulate the eccentric rotational speed by a second frequency based on the vibratory load.

7. The apparatus of claim 6, wherein the vibratory load is based on an operation of a rotor.

8. The apparatus of claim 6, wherein the vibratory load is imposed on an airframe of an aircraft, and wherein the at least one command is configured to cause the actuator to reduce the impact of the vibratory load on the airframe to an amount that is less than a threshold.

9. The apparatus of claim 6, wherein the at least one command is configured to cause the actuator to produce a force output characterized by at least the first and second frequencies.

10. The apparatus of claim 6, wherein the apparatus is configured to obtain the data from at least one sensor coupled to an airframe of an aircraft.

11. A system comprising:
an actuator configured to reduce the impact of a vibratory load imposed on an airframe of a rotorcraft to an amount that is less than a threshold; and
a controller configured to:
obtain data,
determine the vibratory load based on the data, and
set an eccentric rotational speed of an actuator at a first frequency and modulate the eccentric rotational speed by a second frequency based on the vibratory load.

12. The system of claim 11, wherein the vibratory load is based on an operation of a rotor of the rotorcraft.

13. The system of claim 11, wherein the at least one command is configured to cause the actuator to produce a force output characterized by at least the first and second frequencies.

14. The system of claim 13, wherein the force output is opposite in sign to the vibratory load and within the threshold of the vibratory load in terms of magnitude.

15. A system comprising:
a motor configured to spin an eccentric mass to provide a force output characterized by a plurality of frequencies associated with an operation of a rotor; and
an electronics unit coupled to the motor and configured to determine a desirable position of the mass to obtain the force output.

16. The system of claim 15, further comprising:
a computer coupled to the electronics unit and configured to calculate the force output based on an accelerometer measurement and transmit the calculated force output to the electronics unit,
wherein the electronics unit is configured to receive the calculated force output and determine the desirable position of the mass based on the calculated force output.

17. The system of claim 15, wherein the electronics unit is configured to receive feedback regarding an actual position of the mass.

18. The system of claim 15, wherein the plurality of frequencies comprises:
a fundamental frequency associated with the operation of the rotor that is based on a number of blades associated with the rotor, and
a first multiple of the fundamental frequency.

19. The system of claim 15, wherein the plurality of frequencies comprises:
a fundamental frequency associated with the operation of the rotor that is based on a number of blades associated with the rotor, and
a second frequency that differs from the fundamental frequency by an integer.
